(19) United States
(12) Patent Application Publication
(10) Pub. No.: US 2026/0170790 A1
(43) Pub. Date: Jun. 18, 2026

(54) METHOD AND APPARATUS FOR DETECTING OBJECT IN VIDEO BY USING SINGLE IMAGE

(71) Applicants: SK TELECOM CO., LTD., Seoul (KR); KOREA UNIVERSITY RESEARCH AND BUSINESS FOUNDATION, Seoul (KR)

(72) Inventors: Jeong Yeol BAEK, Seoul (KR); Byeong Won LEE, Seoul (KR); Seung Ryong KIM, Seoul (KR); Gyeong Nyeon KIM, Seoul (KR); Seong Hoon PARK, Seoul (KR); Seung Jun AN, Seoul (KR); Chung Hun KANG, Seoul (KR)

(21) Appl. No.: 19/534,894

(22) Filed: Feb. 10, 2026

Related U.S. Application Data
(63) Continuation of application No. PCT/KR2024/015668, filed on Oct. 16, 2024.

(30) Foreign Application Priority Data
Oct. 27, 2023 (KR) 10-2023-0145995

(51) Int. Cl. G06V 10/25; G06V 10/764; G06V 20/70

(52) U.S. Cl. CPC G06V 10/25; G06V 10/764; G06V 20/70

(57) ABSTRACT

A method and an apparatus for detecting an object in a video by using a single image are disclosed. According to one aspect of the present disclosure, a computer-implemented method for detecting an object in a video is provided, comprising: encoding an image feature map extracted from the current frame and a pre-stored memory feature map, the memory feature map including a predetermined number of memory features for each of one or more predictable classes; generating a sampled memory feature map based on the memory feature map and classification scores calculated from the encoded memory feature map; predicting a bounding box and a class of an object in the current frame based on the encoded image feature map and the sampled memory feature map; and updating the memory feature map based on the encoded image feature map.

### CROSS-REFERENCE TO RELATED APPLICATION

This application is a continuation of International Application No. PCT/KR2024/015668, filed Oct. 16, 2024, which is based upon and claims priority to Korean Patent Application No. 10-2023-0145995, filed on Oct. 27, 2023. The entire disclosures of the above applications are incorporated herein by reference.

### TECHNICAL FIELD

The present disclosure relates to a method and an apparatus for detecting an object in a video by using a single image.

### BACKGROUND

The content described below merely provides background information related to the embodiments and does not constitute the related art.

Object detection is a basic and essential task in the field of computer vision, and is widely used in various applications. In particular, object detection for video data is utilized in various applications such as CCTV, autonomous driving, and robot navigation. Although object detection models for a single image have shown a high success rate, when these models are applied directly to video data, performance degradation occurs due to deformation of objects in images caused by movement and occlusion.

To address these problems, video object detection (VOD) models specialized for processing video data have been proposed. The video object detection models utilize optical flow, long short-term memory (LSTM), or attention mechanisms to process sequences of images. Methods using optical flow or LSTM mainly focus on short-term frames close to the current frame, thus having limitations in capturing broader feature representations. Meanwhile, methods based on attention mechanisms obtain global context information from randomly sampled images, which makes it difficult to integrate the overall information of the video data. In addition, video object detection models receive additional reference frames as input or accumulatively store information from all preceding frames in order to utilize the features of adjacent frames, and thus have disadvantages in that unnecessary information is referenced, high computational costs occur, and unnecessary memory usage increases.

### SUMMARY

According to one aspect of the present disclosure, there is provided a computer-implemented method for detecting an object in a video, the computer-implemented method comprising: encoding an image feature map extracted from the current frame and a pre-stored memory feature map, the memory feature map including a predetermined number of memory features for each of predictable classes; generating a sampled memory feature map based on the memory feature map and classification scores calculated from the encoded memory feature map; predicting a bounding box and a class of an object in the current frame based on the encoded image feature map and the sampled memory feature map; and updating the memory feature map based on the encoded image feature map.

According to another aspect of the present disclosure, there is provided an apparatus comprising: a memory configured to store instructions; and at least one processor, the at least one processor being configured, by executing the instructions, to encode an image feature map extracted from a current frame and a pre-stored memory feature map, the memory feature map including a predetermined number of memory features for each of predictable classes, to generate a sampled memory feature map based on the memory feature map and classification scores calculated from the encoded memory feature map, to predict a bounding box and a class of an object in the current frame based on the encoded image feature map and the sampled memory feature map, and to update the memory feature map based on the encoded image feature map.

According to still another aspect of the present disclosure, there is provided a computer program stored on a computer-readable recording medium for executing each of the steps included in the above-described method by a computer.

### BRIEF DESCRIPTION OF DRAWINGS

FIG. 1 is a block diagram schematically illustrating a video object detection apparatus according to an embodiment of the present disclosure.

FIG. 2 is a diagram referenced to describe a structure of a single image object detector according to an embodiment of the present disclosure.

FIG. 3 is a diagram referenced to describe an operation of an update module according to an embodiment of the present disclosure.

FIG. 4 is a diagram referenced to describe an operation of a sampling module according to an embodiment of the present disclosure.

FIG. 5A and FIG. 5B are each diagram referenced to describe structures of a decoder block according to various embodiments of the present disclosure.

FIG. 6 is a flowchart illustrating an object detection method according to an embodiment of the present disclosure.

FIG. 7 is a block diagram schematically illustrating an exemplary computing device that may be used to implement the apparatuses and methods described in the present disclosure.

### DETAILED DESCRIPTION

The present disclosure may provide a single image-based video object detection method and apparatus capable of effectively integrating context information across an entire given dataset.

The features of the present invention are not limited to the problems mentioned above, and other features not mentioned will be clearly understood by those skilled in the art from the following description.

Hereinafter, some embodiments of the present disclosure will be described in detail using exemplary drawings. It should be noted that, in assigning reference numerals to components in each drawing, the same components are given the same reference numerals as much as possible, even if they are shown in different drawings. In addition, in describing the present disclosure, when it is determined that a detailed description of related known configurations or functions may obscure the gist of the present disclosure, the detailed description thereof will be omitted.

In describing components of embodiments according to the present disclosure, signs such as first, second, i), ii), a), and b) may be used. These signs are merely used to distinguish one component from another component, and do not limit the nature, order, or sequence of the component by the signs. When a part of the specification is said to “include” or “comprise” a certain component, this means that other components may be further included rather than excluding other components, unless explicitly stated to the contrary.

The detailed description to be disclosed below with the accompanying drawings is intended to describe exemplary embodiments of the present disclosure, and is not intended to represent the only embodiments in which the present disclosure may be practiced.

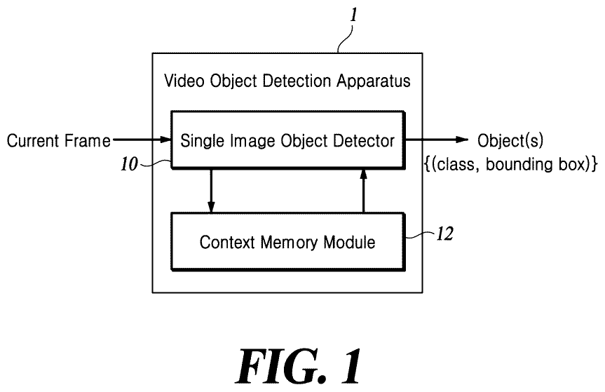

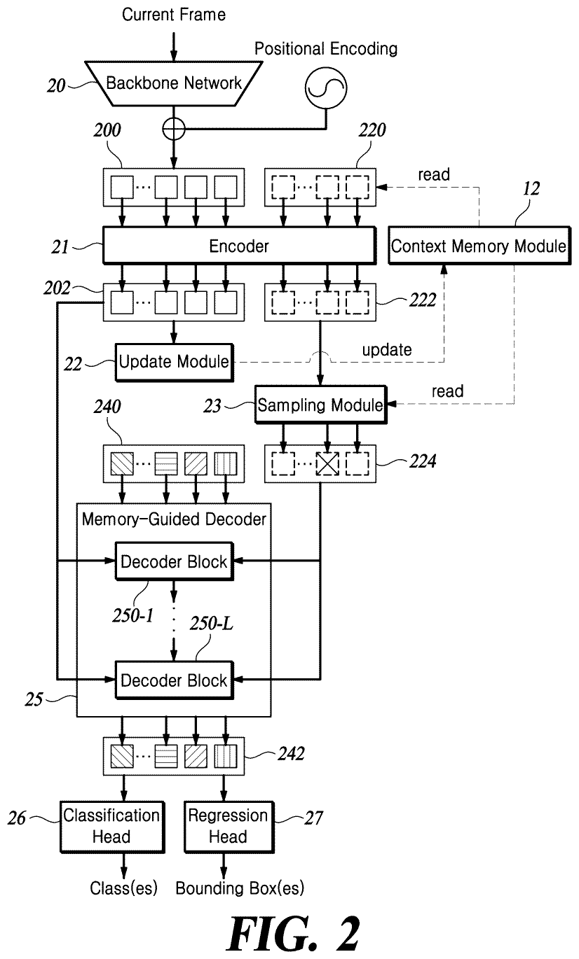

FIG. 1 is a block diagram schematically illustrating a video object detection apparatus according to an embodiment of the present disclosure. FIG. 2 is a diagram illustrating memory features stored in a context memory module according to an embodiment of the present disclosure.

As shown in FIG. 1, a video object detection apparatus 1 according to an embodiment of the present disclosure may include all or part of a single image object detector 10 and a context memory module 12. Not all blocks illustrated in FIG. 1 are essential components, and in other embodiments, some blocks may be added, modified, or removed. Meanwhile, the components illustrated in FIG. 1 represent elements that are functionally distinguished from one another, and at least one component may be implemented in a form integrated with each other in an actual physical environment.

The single image object detector 10 detects one or more objects from a current frame. Detecting an object may include predicting information on a class of the object and information on a bounding box surrounding the object. The information on the class may include, for example, a probability that the object belongs to each of a plurality of predetermined classes and/or an identifier of a class having the highest probability. The information on the bounding box may include, for example, a combination of two or more of an upper-left coordinate of the bounding box, a lower-right coordinate of the bounding box, a center coordinate of the bounding box, and/or a size (width and height) of the bounding box.

The single image object detector 10 may be implemented as a neural network-based model. In describing the present disclosure, it is assumed that the single image object detector 10 has at least some components that follow the architecture of DETR (DEtection TRansformer), which is a Transformer-based detector. However, it should be noted that the technical spirit of the present disclosure may also be applied to a single image object detector having other types of architectures, as long as the detector may operate in conjunction with the context memory module 12.

The context memory module 12 stores temporal and/or spatial context of preceding frames in a fixed size. The context memory module 12 may store, for each predictable class, a fixed number of class-wise feature representations. The feature representation may be referred to as a memory feature or a prototype, and a set thereof may be referred to as a class-wise memory feature map or a memory feature map. For example, the context memory module 12 may store a multi-prototype class-wise memory feature map having a plurality of prototypes for each class. When the number of predictable classes is C and the number of prototypes is K, the memory feature map may be expressed as in Equation 1 below.

$$M = {\{ {m}_{c , k} \}}_{c , k = 1}^{C , K} \qquad [ Equation 1 ]$$

where, c is an identifier indicating a class corresponding to each memory feature, and may have a value between 1 and C. k is an identifier for distinguishing memory features corresponding to the same class, and may have a value between 1 and K. The context memory module 12 may represent each class as a set of prototypes, allowing intra-classes to contain a variety of attributes.

The single image object detector 10 may selectively store, in the context memory module 12, only information necessary in a processing procedure for each frame, and may utilize only information useful for the current frame. Accordingly, for each frame, the single image object detector 10 may efficiently utilize context information on an entire dataset observed up to the present.

Hereinafter, the operation of the single image object detector 10 according to an embodiment of the present disclosure will be described with reference to FIGS. 2 to 5B.

FIG. 2 is a diagram referenced to describe a structure of a single image object detector according to an embodiment of the present disclosure.

The single image object detector 10 may include all or part of a backbone network 20, an encoder 21, an update module 22, a sampling module 23, a memory-guided decoder 25, a classification head 26, and a regression head 27.

The backbone network 20 extracts an image feature map 200 from the current frame. As the backbone network 20, a pre-trained convolutional neural network (CNN) may be used. To provide the encoder 21 with relative spatial positional information of respective features, positional encoding may be added to the image feature map 200. The positional encoding may be generated through fixed functions such as sine and/or cosine functions, or may be generated by an additional learnable embedding layer.

The encoder 21 receives an image feature map 200 extracted by the backbone network 20 and a memory feature map 220 stored in the context memory module 12, and generates an encoded image feature map 202 and an encoded memory feature map 222. The encoder 21 may be implemented as a transformer encoder. The encoder 21 may include a plurality of encoder blocks, and each encoder block may include a multi-head self-attention layer. The encoder 21 may concatenate the image feature map 200 and the memory feature map 220 and sequentially apply the plurality of encoder blocks to the concatenated feature map to generate the encoded image feature map 202 and the encoded memory feature map 222.

Most single image-based object detectors use a transformer encoder to aggregate spatial information from image features extracted from the current frame. By the self-attention structure of the transformer encoder, each image feature may include spatial context information of the current frame. However, when the backbone network 20 extracts ambiguous features for the current frame (for example, when image quality is low or some regions are occluded), it may be difficult to effectively refine the image features. To mitigate this limitation, the encoder 21 according to the present disclosure enhances the image features of each single frame by using fixed-size memory features obtained from all preceding frames. Through this, the image features of the current frame may be improved without directly using data of other frames.

When the image feature map 200, the memory feature map 220, the encoded image feature map 202, and the encoded memory feature map 222 are respectively denoted by F, M, [symbol] , and [symbol] , the encoder 21 may be expressed as in Equation 2 below.

$$[ ℱ , ℳ ] = Enc ( \{ F , M ] ) , where F ∈ {ℝ}^{H \cdot W \times d} and M ∈ {ℝ}^{C \cdot K \times d} \qquad [ Equation 2 ]$$

where, [⋅, ⋅] denotes concatenation between two feature maps, H and W denote a height and a width of the image feature map 200, C denotes a number of classes to be predicted by the single image object detector 10, K denotes a number of class-wise features (i.e., prototypes) stored in the context memory module 12 per class, and d denotes a dimension of the features. As shown in Equation 1, the spatial dimensions of the image feature map 200 may be flattened into one dimension so that the encoder 21 that receives a sequence as input may process the image feature map 200. Likewise, in the memory feature map 220, a class dimension and a prototype dimension may be flattened into one dimension.

In the encoder 21, information on the current frame embedded in the image feature map 200 and spatio-temporal contextual information from preceding frames embedded in the memory feature map 220 are aggregated. Therefore, the encoded image feature map 202 obtains rich context information from the memory feature map 220, and at the same time, the encoded memory feature map 222 acquires class information corresponding to the current frame.

The encoded memory feature map 222 is forwarded to the sampling module 23 to obtain classification scores for the current frame. The encoded image feature map 202 is forwarded to the memory-guided decoder 25 for object detection, and is also forwarded to the update module 22 for memory updating.

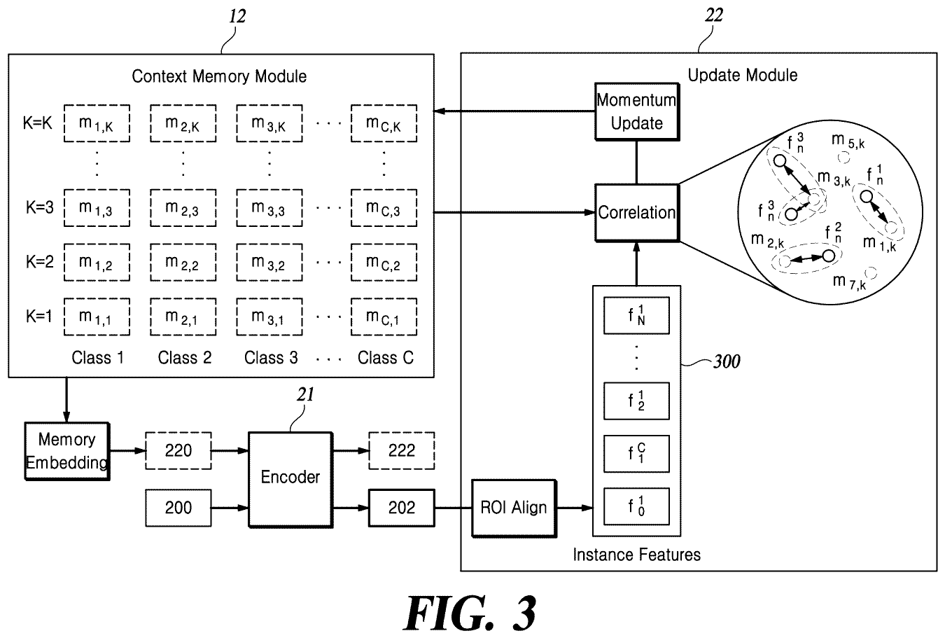

The update module 22 updates at least some of the memory features stored in the context memory module 12 based on the encoded image feature map 202. As a method for updating memory features, a momentum update, which is a non-parametric manner, may be applied. Exemplary embodiments of the update module 22 will be described later with reference to FIG. 3.

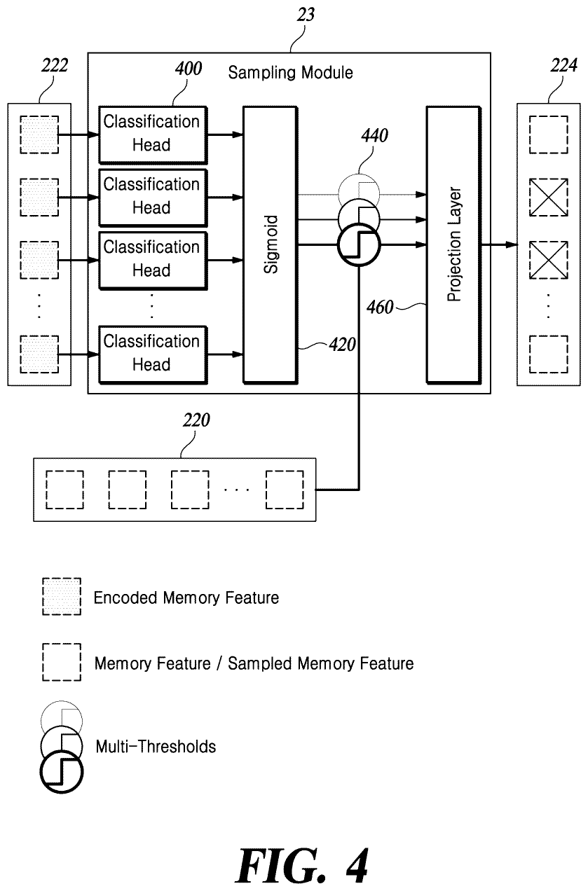

The sampling module 23 samples information required for processing the current frame from the context memory module 12. The sampling module 23 may extract, from among the memory features stored in the context memory module 12, information related to the current image to configure a sampled memory feature map 224. Carefully selecting relevant information from memory is as important as constructing a high-quality memory. Randomly sampling information from memory or using only information of frames adjacent to the current frame cannot guarantee an optimal memory sampling. To address this problem, the sampling module 23 extracts information related to the current frame from the context memory module 12 based on scores calculated from the encoded memory feature map 222. Exemplary embodiments of the sampling module 23 will be described later with reference to FIG. 4.

The encoded memory feature map 222 and the sampled memory feature map 224 are forwarded to the memory-guided decoder 25 to predict a bounding box and a class of an object in the current frame.

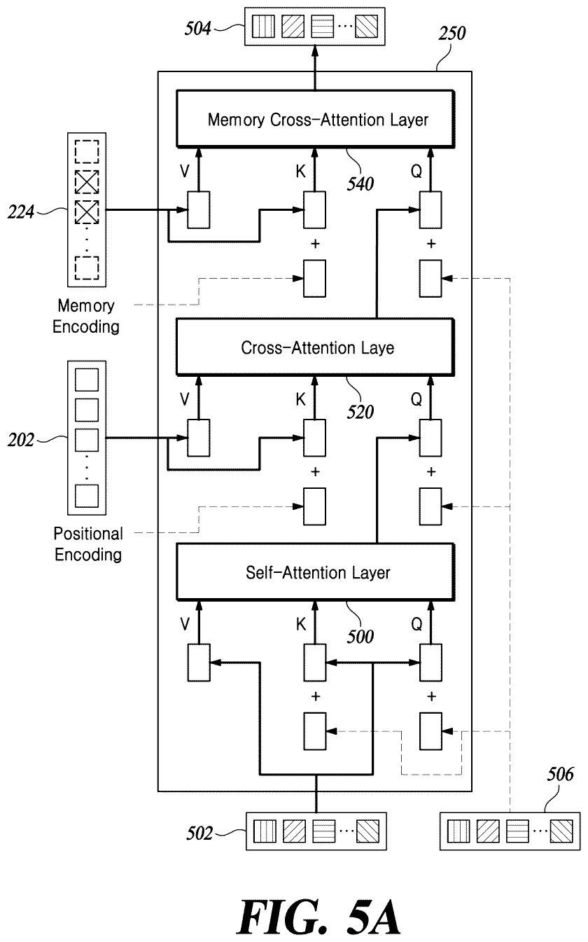

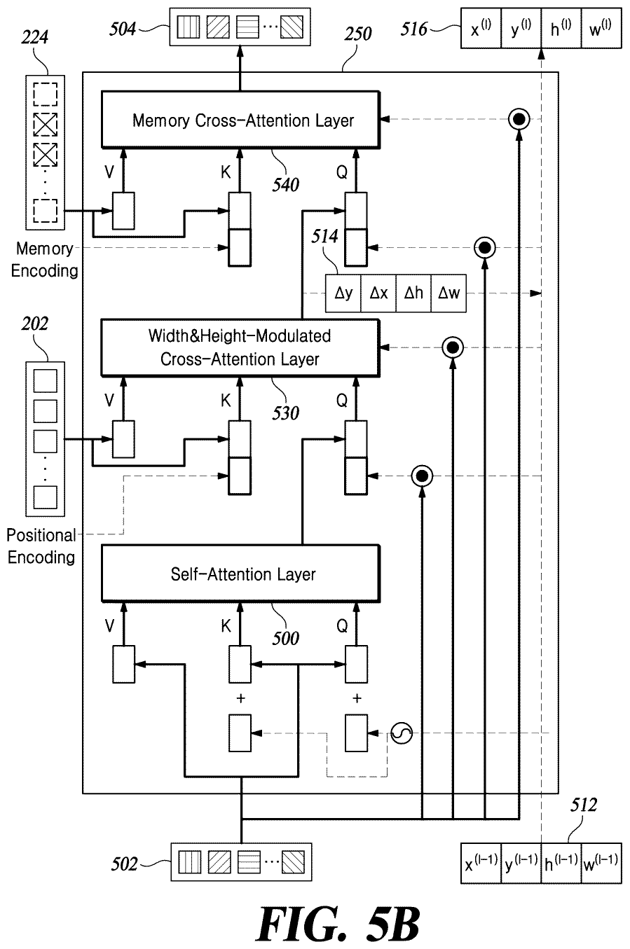

The memory-guided decoder 25 includes one or more decoder blocks 250-1 to 250-L. Each of the decoder blocks 250-1 to 250-L is provided with object queries 240, which are a fixed number of learnable (or learned) positional embeddings, the encoded image feature map 202, and the sampled memory feature map 224. The decoder blocks 250-1 to 250-L may enhance semantic information of the input object queries by utilizing the sampled spatio-temporal memory information. Exemplary embodiments of the decoder blocks 250-1 to 250-L will be described later with reference to FIG. 5A and FIG. 5B.

The classification head 26 and the regression head 27 may predict a set of a predetermined number of classes and bounding boxes by using final object queries 242 output from a last decoder block 240-L. The classification head 26 and the regression head 27 may be configured, for example, as feed-forward networks.

In an inference process, the predicted set of classes and boxes may be output as an object detection result for the current frame. In a training process, the set of bounding boxes and classes predicted by the heads 26 and 27 may be matched with a ground truth (GT) set according to a predetermined matching algorithm, and learnable parameters of the single image object detector 10 may be updated based on a loss calculated from matched pairs. As the matching algorithm and the loss, for example, Hungarian matching and Hungarian loss used in DETR may be employed, but the present disclosure is not limited thereto.

FIG. 3 is a diagram referenced to describe an operation of an update module according to an embodiment of the present disclosure.

The update module 22 extracts one or more instance features 300 from the encoded image feature map 202. In a training process, the instance features 300 may be extracted based on GT bounding boxes, and in an inference process, may be extracted based on predicted bounding boxes. The update module 22 may adjust GT bounding boxes or predicted bounding boxes to a size of a reduced feature map through region-of-interest (Rol) align and may extract the instance features 300 therefrom. The update module 22 may identify a class corresponding to each instance feature based on a GT class or a class predicted by the single image object detector 10. When it is assumed that N instance features 300 are extracted from the encoded image feature map 202, the instance features 300 may be expressed as in Equation 3 below.

$$\tilde{ℱ} = {\{ {f}_{n}^{c} \}}_{n = 1}^{N} \qquad [ Equation 3 ]$$

where, c denotes an identifier of a class corresponding to each instance feature, and may have a value between 1 and C, for example.

The update module 22 may select, from among K memory features corresponding to the same class as each instance feature, a memory feature to be updated based on the instance feature. For example, the update module 22 may select, as a target memory feature to be updated, a memory feature having a highest correlation with the instance feature. The update module 22 may update the selected memory feature based on a momentum update or linear interpolation. For example, an update process of the context memory module 12 may be expressed as in Equation 4 below.

$${m}_{c , {k}_{n}} = α \cdot {m}_{c , {k}_{n}} + ( 1 - α ) \cdot {f}_{n}^{c} , \qquad [ Equation 4 ]$$

$$where {k}_{n} = arg {max}_{k} {\{ 〈 {f}_{n}^{c} , {m}_{c , k} 〉 \}}_{k = 1}^{K}$$

where, [symbol] ⋅, ⋅ [symbol] is defined as a correlation between two features, and α is a momentum coefficient, which may be set to a value greater than or equal to 0 and less than or equal to 1.

The encoded image feature map 202 includes rich context information aggregated from the memory feature map 220. Accordingly, in a sequential processing procedure of a plurality of frames of a video, the memory feature map 220, which is repeatedly updated by the encoded image feature map 202, includes context information on an entire dataset previously observed. In addition, since the memory feature map 220 has multi prototypes per class, it may accommodate diverse distributions of instance features appearing in the entire dataset.

Meanwhile, the context memory module 12 stores features in an embedding space at an output side of the encoder 21. In order to map these features to the same embedding space as the image feature map 200, a memory embedding may be applied to the memory feature map 220 prior to input to the encoder 21. The memory embedding may be performed, for example, by a shallow multi-layer perceptron (MLP).

FIG. 4 is a diagram referenced to describe an operation of a sampling module according to an embodiment of the present disclosure.

The sampling module 23 may generate a sampled memory feature map 224 based on classification scores calculated from the encoded memory feature map 222 and the memory feature map 220. An operation of the sampling module 23 may include a classification process and a multi-threshold sampling process.

In the classification process, the sampling module 23 obtains, from the encoded memory feature map 222 that includes class information for the current frame, classification scores corresponding to respective encoded memory features. In the present disclosure, the classification scores may also be referred to as confidence.

The sampling module 23 may obtain the classification scores by applying each encoded memory feature to a classification head 400 independently configured for the respective encoded memory feature. The classification head 400 may be configured, for example, as a feed-forward network. To represent each classification score as a value between 0 and 1, a sigmoid function 410 may follow the classification head 400. In this case, the encoded memory feature map 222 may be represented as a set of encoded memory features as in Equation 5 below, and a classification score for the k-th encoded memory feature of the c-th class may be calculated as in Equation 6.

$$ℳ = {\{ {m}_{c , k} \}}_{c , k = 1}^{C , K} \qquad [ Equation 5 ]$$

$${p}_{c , k} = Sigmoid ( {FFN}_{c , k} ( {m}_{c , k} ) ) \qquad [ Equation 6 ]$$

where, FFN_{c,k} denotes the classification head 400 corresponding to the k-th encoded memory feature of the c-th class, and Sigmoid(⋅) denotes the sigmoid function.

In the multi-threshold sampling process, the sampling module 23 obtains, for each memory feature constituting the memory feature map 220, a combination of thresholded memory features produced by multiple thresholds 440 having different values and classification scores corresponding to the same class-prototype position. For example, a memory feature corresponding to the k-th memory feature m_{c,k} of the c-th class, thresholded by a t-th threshold τₜ, may be calculated as in Equation 7.

$${\tilde{m}}_{c , k}^{t} = {s}_{c , k}^{t} {m}_{c , k} + ( 1 - {s}_{c , k}^{t} ) ∅ , \qquad [ Equation 7 ]$$

$$where {s}_{c , k}^{t} = δ ( {p}_{c , k} > {τ}_{t} )$$

where, Φ denotes a no-class embedding, which is a learnable embedding (or, in an inference process, a pre-learned embedding). δ(⋅) outputs 1 when a condition is true, and outputs 0 otherwise. That is, a sampling index

$${s}_{c , k}^{t}$$

is a value obtained by binarizing a classification score p_{c,k} for the k-th encoded memory feature of the c-th class with a t-th threshold τₜ.

The sampling module 23 obtains sampled memory features corresponding to respective memory features by embedding combinations of thresholded memory features using a projection layer 460. For example, the sampled memory feature map 224 may be represented, as in Equation 8 below, as a set of sampled memory features corresponding to respective memory features, and a sampled memory feature corresponding to the k-th memory feature of the c-th class may be calculated as in Equation 9.

$$\tilde{M} = {\{ {\tilde{m}}_{c , k} \}}_{c , k = 1}^{C , K} \qquad [ Equation 8 ]$$

$${\tilde{m}}_{c , k} = Proj ( {\tilde{m}}_{c , k}^{1} , {\tilde{m}}_{c , k}^{2} , ⋯ {\tilde{m}}_{c , k}^{T} ) \qquad [ Equation 9 ]$$

where, T denotes a number of thresholds and/or sampling indices, and Proj(⋅) denotes the projection layer 460. The projection layer 460 combines multi-thresholded memory features having different confidence levels to generate sampled memory feature.

In a training process, an asymmetric loss (ASL) may additionally be used to train the classification head 400 and to improve a class discrimination capability of the encoder 21.

FIG. 5A is a diagram referenced to describe structures of a decoder block according to an embodiment of the present disclosure.

As illustrated in FIG. 5A, a decoder block 250 may include a self-attention layer 500, a cross-attention layer 520, and a memory cross-attention layer 540. Each attention layer may be configured as a multi-head attention layer including a plurality of attention heads. Meanwhile, although not illustrated in FIG. 5A, at least some of the attention layers 500, 520, and 540 may be followed by residual connections and normalization layers.

The decoder block 250 may obtain object queries including semantic information for the current frame by sequentially applying object queries 502 output from a preceding decoder block (not shown) to the self-attention layer 500 and the cross-attention layer 520. The decoder block 250 may enhance class information related to the current frame by applying the object queries output from the cross-attention layer 520 to the memory cross-attention layer 540.

The self-attention layer 500 calculates self-attention on object queries 502. The object query output from the self-attention layer 500 of an 1-th decoder block may be expressed as in Equation 10.

$${𝒪}_{s a}^{l} = Self - Attn ( Q = {𝒪}^{l - 1} , K = {𝒪}^{l - 1} , V = {𝒪}^{l - 1} ) \qquad [ Equation 10 ]$$

Where, [symbol] ^{l-1} denotes an object query (or an initial object query) output from an l−1-th decoder block.

The cross-attention layer 520 calculates cross-attention between the object queries output from the self-attention layer 500 and the encoded image feature map 202. An object query output from the cross-attention layer 520 of the l-th decoder block may be expressed as in Equation 11.

$${𝒪}_{c a}^{l} = Cross - Attn ( Q = {𝒪}_{s a}^{l} , K = ℱ , V = ℱ ) \qquad [ Equation 11 ]$$

The memory cross-attention layer 540 calculates cross-attention between the object queries output from the cross-attention layer 520 and the sampled memory feature map 224. An object query 504 output from the memory cross-attention layer 540 of the l-th decoder block may be expressed as in Equation 12.

$${𝒪}_{m c a}^{l} = Mem . Cross - Attn ( Q = {𝒪}_{c a}^{l} , K = \tilde{M} , V = \tilde{M} ) \qquad [ Equation 12 ]$$

Positional information may be added to input tokens for calculating query embeddings and key embeddings in the attention layers 500, 520, and 540. The positional information provided to each of the attention layers 500, 520, and 540 may include, for example, object queries 506, which are learnable (or learned) positional embeddings shared among all decoder blocks 250-1 to 250-L, positional encoding of the image feature map 200, and/or memory encoding. In order to distinguish them from the object queries 506, the object queries 502 output from a preceding decoder block or a preceding attention layer may be referred to as decoder embeddings.

As an example, in the self-attention layer 500, query embeddings and key embeddings may be calculated based on a sum of decoder embeddings 502 output from a preceding decoder block and object queries 506. In another example, in the cross-attention layer 520, query embeddings may be calculated based on a sum of decoder embeddings output from the self-attention layer 500 and the object queries 506, and key embeddings may be calculated based on a sum of the encoded image feature map 202 and positional encoding. In still another example, in the memory attention layer 540, query embeddings may be calculated based on a sum of decoder embeddings output from the cross-attention layer 520 and the object queries 506, and key embeddings may be calculated based on a sum of the sampled memory feature map 224 and memory encoding. Here, the memory encoding may be generated in the same or similar manner as the positional encoding of the image feature map 200, and may serve to indicate that an input token corresponds to features extracted from the context memory module 12.

FIG. 5B is a diagram referenced to describe structures of a decoder block according to another embodiment of the present disclosure.

Referring to FIG. 5B, the decoder block 250 according to another embodiment of the present disclosure may provide positional information extracted from learnable (or learned) anchor boxes 512 to each of the attention layers 500, 530, and 540. In the embodiment, in order to adjust a size of the cross-attention map to match a size of the anchor boxes 512, the cross-attention layer 520 may be replaced with a width&height-modulated cross-attention layer 530. In the width&height-modulated cross-attention layer 530 and the memory cross-attention layer 540, positional information may be concatenated to input tokens for calculating query embeddings and key embeddings.

In the embodiment, the anchor boxes 512 may be updated per decoder-block 250. For example, in each decoder block 250, a variation 514 in position and size of the anchor boxes may be predicted based on an output of the width&height-modulated cross-attention layer 530. Updated new anchor boxes 516 based on the predicted variation 514 may be delivered to a subsequent decoder block (not shown).

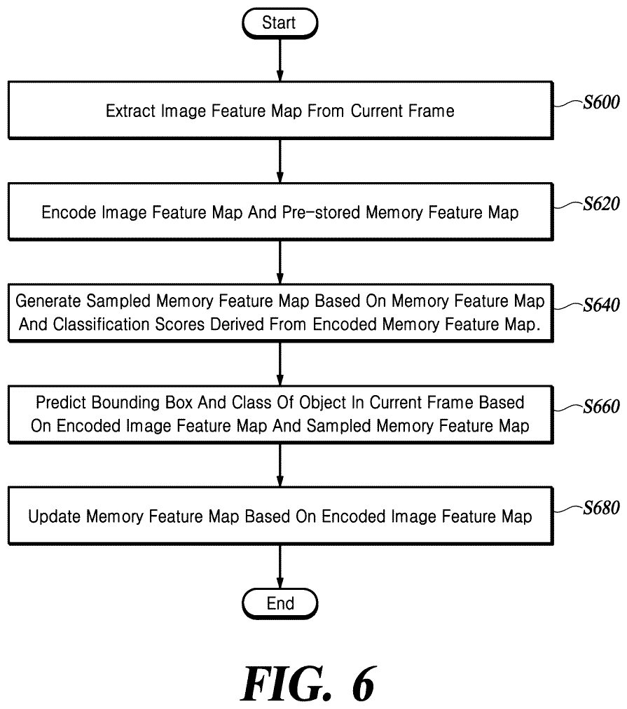

FIG. 6 is a flowchart illustrating an object detection method according to an embodiment of the present disclosure.

The method illustrated in FIG. 6 may be implemented by execution of functions of one or more components of the video object detection apparatus 1 described above by at least one computing device. Thus, the following description will be described in terms of operations performed by the computing device.

The computing device extracts the image feature map from the current frame (S600). The computing device may obtain the image feature map by applying the current frame to a pre-trained backbone network. The computing device may apply positional encoding to the image feature map and adjust a number of dimensions thereof.

The computing device encodes the image feature map and the pre-stored memory feature map (S620). For example, the computing device may read the memory feature map from a context memory module. The memory feature map may include a predetermined number of memory features for each of one or more predictable classes. The computing device may concatenate the image feature map and the memory feature map, and may obtain an encoded image feature map and an encoded memory feature map based on self-attention applied to the concatenated feature map. The encoded image feature map may embed spatio-temporal context of all frames observed before the current frame, and the encoded memory feature map may embed information on classes of objects in the current frame. The encoded memory feature map may include encoded memory features, each corresponding to a respective memory feature. An encoded memory feature corresponding to a specific memory feature may have the same class-prototype position as the corresponding memory feature.

The computing device generates a sampled memory feature map based on the memory feature map and classification scores calculated from the encoded memory feature map (S640). The sampled memory feature map may include sampled memory features, each corresponding to a respective memory feature. A sampled memory feature corresponding to a specific memory feature may have the same class-prototype position as the corresponding memory feature. The computing device may calculate a classification score for each encoded memory feature. The computing device may threshold a memory feature corresponding to each encoded memory feature based on one or more predetermined thresholds. For example, the computing device may obtain one or more sampling indices by binarizing a classification score corresponding to a specific class-prototype position based on the one or more predetermined thresholds, and may select, as a thresholded memory feature, either a memory feature at the corresponding class-prototype position or a no-class embedding based on a value of each sampling index. For example, the computing device may select, as a thresholded memory feature, either a memory feature corresponding to each encoded memory feature or a no-class embedding, based on the value of each sampling index. The computing device may generate a sampled memory feature corresponding to each memory feature by embedding one or more thresholded memory features selected for each sampling index.

The computing device predicts a bounding box and a class of an object in the current frame based on the encoded image feature map and the sampled memory feature map (S660). The computing device may obtain an output object query, in which semantic information on the current frame and information on a class related to the current frame is enhanced, by applying an object query to a memory-guided decoder, and may predict the bounding box and the class of the object from the output object query.

The memory-guided decoder may include one or more decoder blocks. Each decoder block may include a first attention layer configured to generate a first object query based on self-attention on an input object query, a second attention layer configured to generate a second object query based on cross-attention between the first object query and the encoded image feature map, and a third attention layer configured to generate a third object query based on cross-attention between the second object query and the sampled memory feature map. The computing device may combine memory embeddings indicating positions (e.g., class-prototype positions) of memory features corresponding to respective sampled memory features with the sampled memory feature map and provide the combined result to the third attention layer.

The computing device updates the memory feature map based on the encoded image feature map (S680). The computing device may extract one or more instance features from the encoded image feature map based on a predicted bounding box or a predetermined ground truth (GT) bounding box, and may update one or more target memory features corresponding to the extracted instance features from the memory feature map. Here, each target memory feature may be selected from among memory features corresponding to the same class as the respective instance feature. For example, among memory features corresponding to the same class as a specific instance feature, a memory feature having the highest correlation with the instance feature may be selected as the target memory feature corresponding to the instance feature. The target memory feature corresponding to a specific instance feature may be updated based on linear interpolation between the respective instance feature and the corresponding target memory feature.

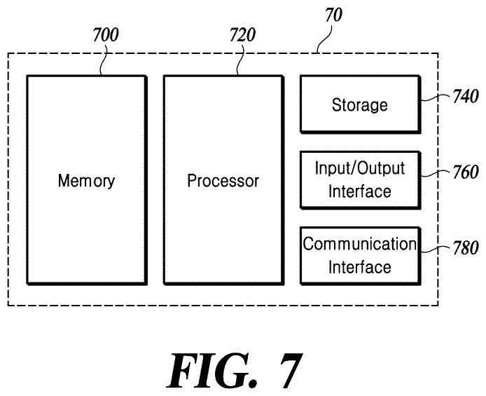

FIG. 7 is a block diagram schematically illustrating an exemplary computing device that may be used to implement the apparatuses and methods described in the present disclosure.

The computing device 70 may include some or all of a memory 700, a processor 720, a storage 740, an input/output interface 760, and a communication interface 780. The computing device 70 may structurally and/or functionally include at least a some of the video object detection apparatus 1. The computing device 70 may be not only a stationary computing device such as a desktop computer or a server, but also a mobile computing device such as a laptop computer or a smart phone. The computing device 70 may also be implemented as any specialized hardware accelerator capable of efficiently processing operations for an artificial intelligence model. For example, the computing device 70 may be implemented as a graphic processing unit (GPU), a Tensor Processing Unit (TPU), or a neural processing unit (NPU).

The memory 700 may store a program that causes the processor 720 to perform a method or operation according to various embodiments of the present disclosure. For example, the program may include a plurality of instructions executable by the processor 720, and, by execution of the plurality of instructions by the processor 720, the method illustrated in FIG. 6 may be performed. The memory 700 may be a single memory or a plurality of memories. In this case, information necessary to perform the method or operation according to various embodiments of the present disclosure may be stored in a single memory or may be distributed and stored in the plurality of memories. When the memory 700 is configured as the plurality of memories, the plurality of memories may be physically separated from each other. The memory 700 may include at least one of a volatile memory and a non-volatile memory. The volatile memory may include, for example, a static random access memory (SRAM) or a dynamic random access memory (DRAM), and the non-volatile memory may include, for example, a flash memory.

The processor 720 may include at least one core capable of executing at least one instruction. The processor 720 may execute instructions stored in the memory 700. The processor 720 may be a single processor or a plurality of processors.

The storage 740 retains stored data even when power supplied to the computing device 70 is cut off. For example, the storage 740 may include a non-volatile memory, and may include a storage medium such as a magnetic tape, an optical disc, or a magnetic disc.

The program stored in the storage 740 may be loaded into the memory 700 before being executed by the processor 720. The storage 740 may store files written in a programming language, and a program generated from the files by a compiler or the like may be loaded into the memory 700. The storage 740 may store data to be processed by the processor 720 and/or data processed by the processor 720.

The input/output interface 760 may include an input device such as a touch interface, a keyboard, or a mouse, and may include an output device such as a display device or a speaker. A user may trigger execution of a program by the processor 720 and/or check results processed by the processor 720 through the input/output interface 760.

The communication interface 780 may provide access to an external network. For example, the computing device 70 may communicate with other devices (e.g., a camera) through the communication interface 780.

Each component of the apparatus or method according to the present disclosure may be implemented in hardware or software, or by a combination of hardware and software. In addition, the function of each component may be implemented in software and a microprocessor may be configured to execute the software function corresponding to each component.

Various implementations of the systems and techniques described in the present specification may be realized in digital electronic circuitry, integrated circuitry, a field programmable gate array (FPGA), an application specific integrated circuit (ASIC), computer hardware, firmware, software, and/or combinations thereof. Such various implementations may include one or more computer programs executable on a programmable system. The programmable system includes at least one programmable processor (which may be a special-purpose processor or a general-purpose processor) coupled to receive data and instructions from, and transmit data and instructions to, a storage system, at least one input device, and at least one output device. The computer programs (also known as programs, software, software applications, or code) include instructions for a programmable processor and are stored in a “computer-readable recording medium”.

The computer-readable recording medium includes all types of recording devices in which data readable by a computer system is stored. Such a computer-readable recording medium may be a non-volatile or non-transitory medium such as a ROM, a CD-ROM, a magnetic tape, a floppy disk, a memory card, a hard disk, an optical-magnetic disk, or a storage device, and may further include a transitory medium such as a data transmission medium. In addition, the computer-readable recording medium may be distributed across computer systems connected over a network, such that computer-readable code is stored and executed in a distributed manner.

In the flowcharts/timing diagrams of the present specification, each process is described as being executed sequentially; however, this is merely illustrative of the technical idea of an embodiment of the present disclosure. In other words, a person having ordinary skill in the art to which an embodiment of the present disclosure pertains may modify and change the order described in the flowcharts/timing diagrams, or execute one or more of the processes in parallel, without departing from the essential characteristics of the embodiment of the present disclosure. Accordingly, the flowcharts/timing diagrams are not limited to a chronological order.

According to an embodiment of the present disclosure, by utilizing a context memory module, context information across all observed data may be effectively integrated. Accordingly, there is an effect in that robust object detection may be achieved based on an understanding of the environment in which a camera is installed.

According to an embodiment of the present disclosure, temporal context from previous frames may be utilized without inputting additional reference frames or using an auxiliary network. Accordingly, there is an effect in that a decrease in processing speed caused by the reference frames or the auxiliary network may be prevented, which satisfies real-time requirements essential for practical applications.

According to an embodiment of the present disclosure, only necessary information among information extracted and processed from the current frame is selectively stored such that the context memory module can be maintained at a fixed size. In addition, by score-based sampling, information relevant to the current frame may be effectively captured from the context memory module.

The features of the present disclosure are not limited to the effects mentioned above, and other features will be clearly understood by those skilled in the art from the description.

The above description is merely illustrative of the technical idea of an embodiment of the present disclosure, and various modifications and variations may be made by a person having ordinary skill in the art without departing from the essential characteristics of the embodiment. Therefore, the embodiments are intended to describe rather than limit the technical idea of the embodiment, and the scope of the technical idea of the embodiment is not limited by the embodiments. The scope of protection of the embodiment shall be interpreted according to the following claims, and all technical ideas within an equivalent scope shall be interpreted as being included in the scope of rights of the embodiment.

What is claimed is:

1. A computer-implemented method for detecting an object in a video, the computer-implemented method comprising:
encoding an image feature map extracted from the current frame and a pre-stored memory feature map, the memory feature map including a predetermined number of memory features for each of one or more predictable classes;
generating a sampled memory feature map based on the memory feature map and classification scores calculated from the encoded memory feature map;
predicting a bounding box and a class of an object in the current frame based on the encoded image feature map and the sampled memory feature map; and
updating the memory feature map based on the encoded image feature map.

2. The computer-implemented method according to claim 1, wherein the updating comprises:
extracting one or more instance features from the encoded image feature map based on the predicted bounding box or a pre-designated ground truth (GT) bounding box; and
updating one or more target memory features corresponding to the extracted instance features in the memory feature map, wherein each target memory feature is selected from among the memory features corresponding to the same class as the respective instance feature.

3. The computer-implemented method according to claim 2, wherein updating the target memory features comprises:
updating each target memory feature based on linear interpolation between the respective instance feature and the corresponding target memory feature.

4. The computer-implemented method according to claim 2, wherein the updating further comprises:
selecting, as the target memory feature, a memory feature having a highest correlation with each instance feature among the memory features corresponding to the same class as each instance feature.

5. The computer-implemented method according to claim 1, wherein the encoding comprises:
concatenating the image feature map and the memory feature map; and
obtaining, based on self-attention on the concatenated feature map, the encoded image feature map, wherein the encoded image feature map embeds spatio-temporal context of all frames observed before the current frame, and the encoded memory feature map embeds information on classes of objects in the current frame.

6. The computer-implemented method according to claim 1, wherein:
the encoded memory feature map and the sampled memory feature map respectively comprise encoded memory features and sampled memory features, each corresponding to a respective memory feature, and
the generating comprises:
calculating a classification score for each encoded memory feature;
thresholding memory features corresponding to the respective encoded memory features based on one or more predetermined thresholds; and
generating sampled memory features corresponding to the respective memory features by embedding one or more thresholded memory features.

7. The computer-implemented method according to claim 6, wherein the thresholding comprises:
binarizing the classification scores based on one or more predetermined thresholds to obtain one or more sampling indices; and
selecting, as a thresholded memory feature, either a memory feature corresponding to each encoded memory feature or a no-class embedding, based on the value of each sampling index.

8. The computer-implemented method according to claim 1, wherein the predicting comprises:
applying an object query to a memory-guided decoder to obtain an output object query in which semantic information for the current frame and information on a class associated with the current frame is enhanced; and
predicting the bounding box and the class of the object from the output object query.

9. The computer-implemented method according to claim 8, wherein the memory-guided decoder comprises one or more decoder blocks, each decoder block comprising:
a first attention layer configured to generate a first object query based on self-attention on an input object query;
a second attention layer configured to generate a second object query based on cross-attention between the first object query and the encoded image feature map; and
a third attention layer configured to generate a third object query based on cross-attention between the second object query and the sampled memory feature map.

10. The computer-implemented method according to claim 9, wherein:
the sampled memory feature map comprises sampled memory features corresponding to respective memory features, and
the obtaining of the output object query comprises:
combining memory embeddings indicating positions of the memory features corresponding to the respective sampled memory features with the sampled memory feature map, and providing the combined result to the third attention layer.

11. An apparatus comprising:
a memory configured to store instructions; and
at least one processor,
wherein the at least one processor is configured, by executing the instructions,
to encode an image feature map extracted from a current frame and a pre-stored memory feature map, the memory feature map including a predetermined number of memory features for each of predictable classes;
to generate a sampled memory feature map based on the memory feature map and classification scores calculated from the encoded memory feature map;
to predict a bounding box and a class of an object in the current frame based on the encoded image feature map and the sampled memory feature map; and
to update the memory feature map based on the encoded image feature map.

12. The apparatus according to claim 11, wherein the at least one processor, in updating the memory feature map, is configured to:
extract one or more instance features from the encoded image feature map based on the predicted bounding box or a pre-designated ground truth (GT) bounding box, and
update one or more target memory features corresponding to the extracted instance features in the memory feature map, wherein each target memory feature is selected from among the memory features corresponding to the same class as the respective instance feature.

13. The apparatus according to claim 12, wherein the one or more target memory features are updated based on linear interpolation between each instance feature and a target memory feature corresponding to each instance feature.

14. The apparatus according to claim 12, wherein the target memory feature is a memory feature having a highest correlation with each instance feature among the memory features corresponding to the same class as each instance feature.

15. The apparatus according to claim 11, wherein the at least one processor, in encoding the image feature map and the memory feature map, is configured to:
concatenate the image feature map and the memory feature map; and
obtain, based on self-attention on the concatenated feature map, the encoded image feature map, wherein the encoded image feature map embeds spatio-temporal context of all frames observed before the current frame, and the encoded memory feature map embeds information on classes of objects in the current frame.

16. The apparatus according to claim 11, wherein
the encoded memory feature map and the sampled memory feature map respectively comprise encoded memory features and sampled memory features, each corresponding to a respective memory feature, and
the at least one processor, in generating the sampled memory feature map, is configured to:
calculate a classification score for each encoded memory feature;
threshold a memory feature corresponding to each encoded memory feature based on one or more predetermined thresholds; and
generate a sampled memory feature corresponding to each memory feature by embedding one or more thresholded memory features.

17. The apparatus according to claim 16, wherein the at least one processor, in thresholding the memory features, is configured to:
binarize the classification scores based on one or more predetermined thresholds to obtain one or more sampling indices; and
select as a thresholded memory feature, either a memory feature corresponding to each encoded memory feature or a no-class embedding, based on the value of each sampling index.

18. The apparatus according to claim 11, wherein the at least one processor, in predicting the bounding box and the class of the object, is configured to:
apply an object query to a memory-guided decoder to obtain an output object query in which semantic information for the current frame and information on a class associated with the current frame is enhanced; and
predict the bounding box and the class of the object from the output object query.

19. The apparatus according to claim 18, wherein the memory-guided decoder comprises one or more decoder blocks, each decoder block comprising:
a first attention layer configured to generate a first object query based on self-attention on an input object query;
a second attention layer configured to generate a second object query based on cross-attention between the first object query and the encoded image feature map; and
a third attention layer configured to generate a third object query based on cross-attention between the second object query and the sampled memory feature map.

20. A non-transitory computer-readable recording medium having instructions stored thereon, wherein the instructions, when executed by the computer, cause the computer to:
encode an image feature map extracted from a current frame and a pre-stored memory feature map, the memory feature map comprising a predetermined number of memory features for each of one or more predictable classes;
generate a sampled memory feature map based on the memory feature map and classification scores calculated from the encoded memory feature map;
predict a bounding box and a class of an object in the current frame based on the encoded image feature map and the sampled memory feature map; and
update the memory feature map based on the encoded image feature map.
